(19) United States
(12) Patent Application Publication
(10) Pub. No.: US 2015/0336105 A1
(43) Pub. Date: Nov. 26, 2015

(54) APPARATUS FOR DESTRUCTION OF STORAGE MEDIA DEVICES

(71) Applicants: JAMES WAGNER, Harrison City, PA (US); Thomas Wagner, Murrysville, PA (US)

(72) Inventors: JAMES WAGNER, Harrison City, PA (US); Thomas Wagner, Murrysville, PA (US)

(21) Appl. No.: 14/283,621

(22) Filed: May 21, 2014

(51) Int. Cl. B02C 19/20; B02C 21/02

(52) U.S. Cl. CPC B02C 19/20; B02C 21/026

(57) ABSTRACT

An apparatus for destroying storage media devices includes a receptacle member having an open top end, a closed bottom end and a peripheral side wall or a pair of side walls defining a hollow interior of the receptacle member. A member is mounted for a rotation adjacent the receptacle member and has an abrasive working surface. An electric motor causes the rotation of the member and a chute is positioned to deliver the one or more storage media devices into the hollow interior of the receptacle member. A cylinder and a pump urge the storage media devices into a contact with the abrasive working surface. The rotation of the abrasive member transforms at least a portion of the storage media devices contacting the abrasive member into particles, whereby the storage media devices are destructed sufficiently to prevent data mining from remnant(s) thereof or from the particles.

### FIELD OF THE INVENTION

The present invention relates, in general, to a destruction of storage media devices used for storage and retrieval of digital information and, more particularly, this invention relates to an apparatus configured to destruct hard drives by way of a rotating member having an abrasive working surface.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, destruction of the storage media devices, for example such as hard drives, is a subject to regulatory requirements, as well as business safety and security practices and expectations. Of a particular interest is a destruction of the data storage devices in a manner that prevents subsequent retrieval of data from damaged or destroyed hard drives, including remnants thereof.

Prior to conception and development of the instant invention, efforts have been made to prevent such subsequent retrieval of data from damaged or destroyed hard drives. U.S. Pat. No. 8,251,303 issued to Wozny on Aug. 28, 2012 provides a system for destroying a memory device that includes a grind chamber with a rotatable grind wheel positioned therein and having an upwardly facing abrasive working surface. A pressure arm presses the memory device against the grind wheel as the grind wheel rotates. The rotating grind wheel grinds the memory device into particles from which the data stored on the memory device cannot be recovered. The particles are collected in a receptacle adjacent the grind wheel. The system may include a plurality of guides configured to maintain the memory device in a substantially stationary position relative to the pressure arm as the grind wheel grinds the memory device into particles.

However, Wozny is limited to processing one hard drive at a time and thus is disadvantaged, at least from a cost effective stand point, for use in a high volume or batch applications requiring cost effective destruction of a large quantity of hard drive.

Therefore, there is a need for an improved apparatus for destroying storage media devices used for storage and retrieval of digital information in a manner that allows a high volume or batch operation and in a manner that prevents subsequent retrieval of data from damaged or destroyed devices, including remnants thereof.

### SUMMARY OF THE INVENTION

The invention provides an apparatus for destroying storage media devices used for storage and retrieval of digital information that comprises a receptacle member having an open top end, a closed bottom end and a peripheral side wall or a pair of side walls defining a hollow interior of the receptacle member, the hollow interior of the receptacle member sized to receive therein one or more storage media devices; a member is mounted for a rotation adjacent the receptacle member and has an abrasive working surface; a means is provided for causing the rotation of the member having the abrasive working surface; a chute is positioned to deliver one or more storage media devices into the hollow interior of the receptacle member and onto an inner surface of the closed bottom end; a means for urging such one or more storage media devices for a contact with the abrasive working surface is also provided. The rotation of the member transforms at least a portion of the one or more storage media devices contacting the abrasive member into particles, whereby such one or more storage media devices are destructed or transformed sufficiently to prevent data mining from remnant(s) thereof or from the particles.

The invention also provides an apparatus for destroying storage media devices used for storage and retrieval of digital information that comprises a frame having a hollow interior; a receptacle member positioned within the hollow interior and having an open top end, a closed bottom end and a peripheral side wall defining a hollow interior of the receptacle member, the closed bottom end having an irregular inner surface, the hollow interior of the receptacle member sized to receive therein one or more storage media devices; apertures formed through the peripheral side wall at least in proximity to the closed bottom end; a hydraulic cylinder operatively disposed in a vertical plane, the hydraulic cylinder having a stationary portion thereof attached to one portion of the frame and having a movable portion thereof attached to an outer surface of the closed end of the receptacle member; a pump assembly coupled to the hydraulic cylinder and operable to generate a flow of a hydraulic fluid through the hydraulic cylinder, the flow causing a reciprocal vertical movement of the receptacle member; a guide mounted within the hollow interior of the frame in operative engagement with the receptacle member, the guide configured to aid in the reciprocal vertical movement of the receptacle member; a member sized and shaped to fit into the hollow interior of the receptacle member during use of the apparatus; an abrasive material disposed on a first surface of the member and defining an abrasive working surface thereof, the abrasive working surface positioned, at assembly, toward the irregular inner surface of the closed bottom end of the receptacle member; an elongated member having a proximal end thereof rigidly attached to an axially opposite second surface of the member, the elongated member extending in a vertical plane; an electric motor attached to one portion of the frame; a power transmission member operatively connecting an output shaft of the electric motor and a distal end of the elongated member, the electric motor and the power transmission member operable to cause a rotation of the elongated member, the member and the abrasive material about a vertical axis, wherein the first surface of the member rotates in a horizontal plane; a chute attached at an angle to the frame and positioned to deliver, preferably due to gravity, the one or more storage media devices into the hollow interior of the receptacle member and onto the irregular inner surface of the closed bottom end; wherein the vertical movement of the receptacle member in an upward direction urges the one or more storage media devices into a contact with the abrasive material; wherein the irregular inner surface at least minimizes lateral movement of such one or more storage media devices delivered thereonto; wherein the rotation of the abrasive material transforms at least a portion of such one or more storage media devices contacting the abrasive material into particles that exit the hollow interior of the receptacle member through the apertures formed through a side wall thereof; and whereby such one or more storage media devices are destructed or transformed sufficiently to prevent data retrieval from remnant(s) thereof or from the particles.

The invention additionally provides an apparatus for destroying storage media devices used for storage and retrieval of digital information that comprises a frame, having a hollow interior; a receptacle member having an open top end, a closed bottom end and a pair of side wall upstanding on an inner surface of the closed bottom end and defining a hollow interior of the receptacle member, the hollow interior of the receptacle member sized to receive therein one or more storage media devices; a plate shaped member sized and shaped to fit into the hollow interior of the receptacle member and having each end thereof positioned in a close proximity to an inner surface of a respective side wall; a hydraulic cylinder operatively disposed in a horizontal plane, the hydraulic cylinder having a stationary portion thereof attached to one portion of the frame and having a movable portion thereof attached to a surface of the member; a pump assembly coupled to the hydraulic cylinder and operable to generate a flow of a hydraulic fluid through the hydraulic cylinder, the flow causing a reciprocal horizontal movement of the plate shaped member within the hollow interior of the receptacle member; an elongated member mounted for a rotation about a horizontal axis; a wheel mounted on the elongated member for the rotation therewith, the wheel having a width thereof being sized to fit into the hollow interior of the receptacle member; an abrasive material disposed on a peripheral surface of the wheel for a rotation therewith and defining an abrasive working surface thereof; an electric motor attached to one portion of the frame; a power transmission member operatively connecting an output shaft of the electric motor and a distal end of the axle, the electric motor and the power transmission member operable to cause a rotation of the elongated member, the wheel and the abrasive material about the horizontal axis; a chute attached at an angle to the receptacle member and positioned to deliver, preferably due to gravity, such one or more storage media devices into the hollow interior of the receptacle member and onto an inner surface of the closed bottom end; wherein the horizontal movement of the plate shaped member in a direction toward the wheel urges such one or more storage media devices into a contact with the abrasive material; wherein the rotation of the abrasive material transforms at least a portion of such one or more storage media devices contacting the abrasive material into particles; and whereby the one or more storage media devices are destructed sufficiently to prevent data retrieval from remnant(s) thereof or from the particles.

### OBJECTS OF THE INVENTION

It is, therefore, one of the primary objects of the present invention to provide an apparatus for destroying storage media devices used for storage and retrieval of digital information.

Another object of the present invention is to provide an apparatus for destroying storage media devices used for storage and retrieval of digital information that includes a rotating grinding or sanding abrasive member.

Yet another object of the present invention is to provide an apparatus for destroying storage media devices used for storage and retrieval of digital information that prevents subsequent retrieval of data from damaged or destroyed storage media devices.

A further object of the present invention is to provide an apparatus for destroying storage media devices used for storage and retrieval of digital information that is cost effective for a high volume and/or batch operation.

Yet a further object of the present invention is to provide an apparatus for destroying storage media devices used for storage and retrieval of digital information that is configured to destroy a single or a plurality of storage media devices.

An additional object of the present invention is to provide an apparatus for destroying storage media devices used for storage and retrieval of digital information that includes a hollow receptacle configured to receive a plurality of storage media devices therewithin and a chute configured to deliver such plurality of storage media devices.

Another object of the present invention is to provide an apparatus for destroying storage media devices used for storage and retrieval of digital information that includes a hydraulic cylinder and pump assembly so as to push plurality of storage media devices into a contact with a rotating abrasive wheel or disk.

A further object of the present invention is to provide an apparatus for destroying storage media devices used for storage and retrieval of digital information that is portable.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 illustrates a planar top diagrammatic view of an apparatus for destroying storage media devices used for storage and retrieval of digital information;

FIG. 2 illustrates a front elevation diagrammatic view of the apparatus of FIG. 1, in a condition to load a plurality of storage media devices;

FIG. 3 illustrates a front elevation diagrammatic view of the apparatus of FIGS. 1-2, in a condition wherein a plurality of storage media devices are urged into a contact with a rotating abrasive member;

FIG. 4 is a perspective view of the apparatus of FIGS. 1-3, particularly illustrating a receptacle configured to receive the plurality of storage media devices within a hollow interior thereof and an abrasive disk mounted for a rotation and sized to fit within the hollow interior of the receptacle member;

FIG. 5 illustrates a planar top diagrammatic view of another embodiment of the apparatus for destroying storage media devices used for storage and retrieval of digital information;

FIG. 6 illustrates a front elevation diagrammatic view of the apparatus of FIG. 5;

FIG. 7 is a partial perspective view of the apparatus of FIGS. 5-6, particularly illustrating a receptacle configured to receive the plurality of storage media devices within a hollow interior thereof and an abrasive wheel mounted for a rotation adjacent one end of the receptacle member;

FIG. 8 illustrates a front elevation diagrammatic view of an alternative form the apparatus of FIG. 5;

FIG. 9 illustrates a partial planar top diagrammatic view of yet another embodiment of an apparatus for destroying storage media devices used for storage and retrieval of digital information;

FIG. 10 illustrates a partial front elevation diagrammatic view of the apparatus of FIG. 9; and

FIG. 11 illustrates an elevation diagrammatic view of a truck mounted mobile storage media destruction system employing any apparatus of FIGS. 1-10.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a storage media device applies but is not limited to removable and non-removable devices such as floppy discs, CD ROMs, tapes, internal hard drives, external hard drives, USB flash drives and the like.

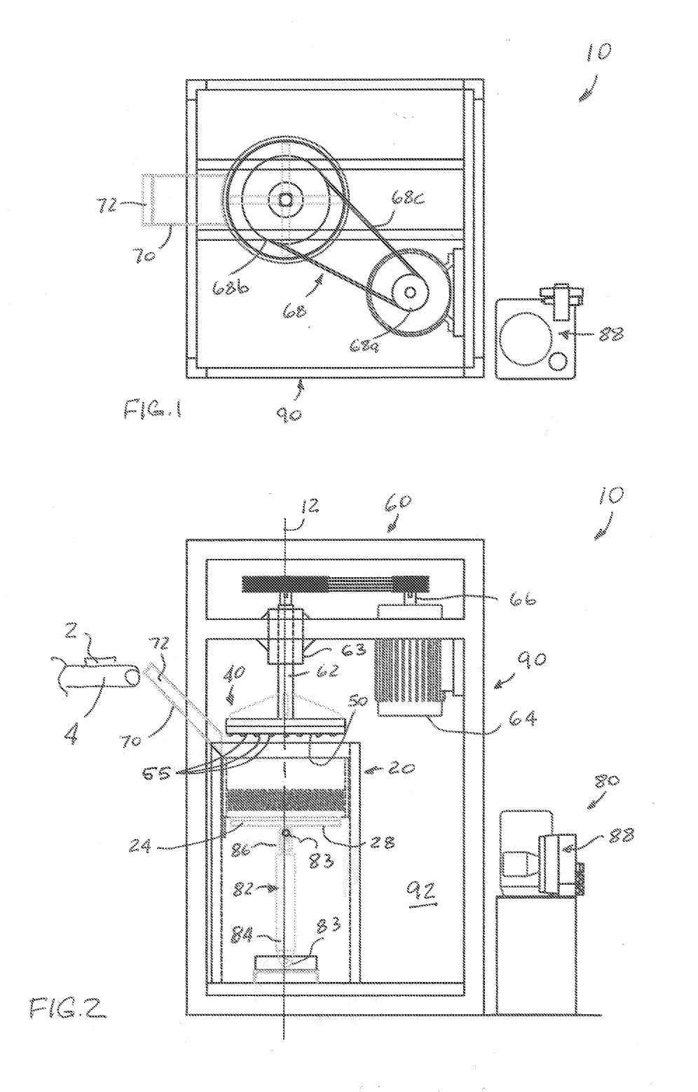

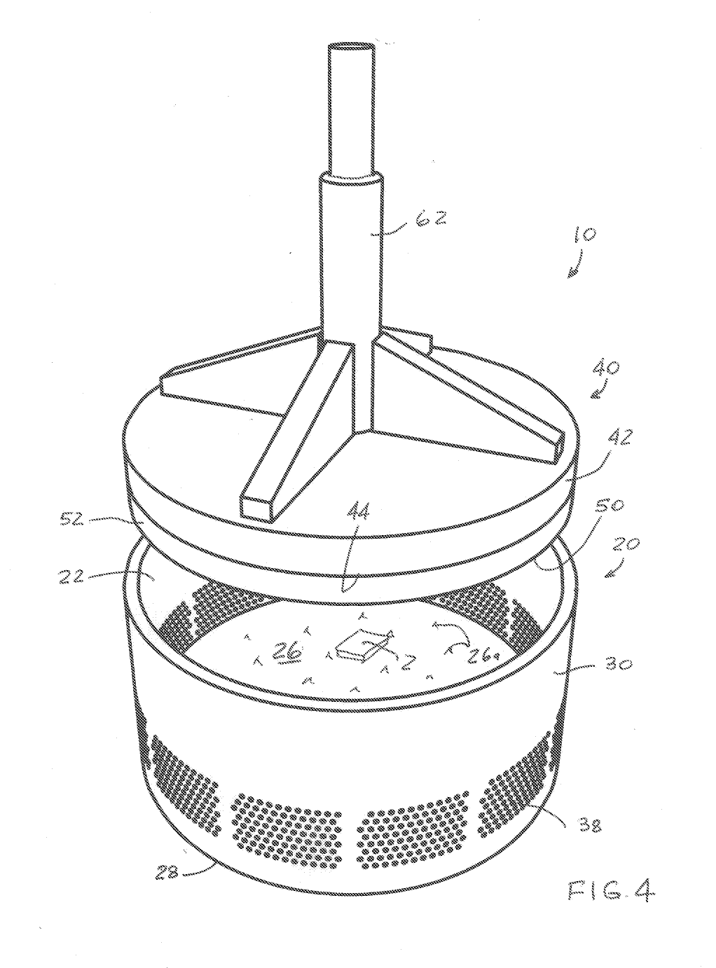

Reference is now made, to FIGS. 1-4, wherein there is shown an apparatus, generally designated as 10, for destroying storage media devices 2 used for storage and retrieval of digital information. The apparatus 10 comprises a receptacle member, generally designated as 20, having an open top end 22, a closed bottom end 24 and a peripheral side wall 30 defining a hollow interior 36 of the receptacle member 20. The hollow interior 36 of the receptacle member 20 is sized to receive therein at least one and preferably a plurality of storage media devices 2. Preferably, an inner surface 26 of the closed bottom end 24 has an irregular shape that at least minimizes a lateral movement of the one or more storage media devices 2 delivered thereonto. By way of one example only, such irregular inner surface 26 may be defined by projections 26a. It is also contemplated that in applications, where the one or more storage media devices 2 are not required to be completely destroyed, the inner surface 26 may be generally smooth and adapted with a non-slip elastic material, either completely or in sections, to essentially increase a friction with the surface of the one or more storage media devices 2 during operation, thus at least minimizing the lateral movement thereof. It is also contemplated that the projections 26a may be manufactured from or coated with such non-slip elastic material. By way of examples only, such non-slip elastic material may be of the type as used on protective cases for mobile phones and/or tool handles.

Furthermore, for the reasons to be described later, the receptacle member 20 has apertures 38 formed through the peripheral side wall 30 at least in a proximity to the inner surface 26 of the closed bottom end 24.

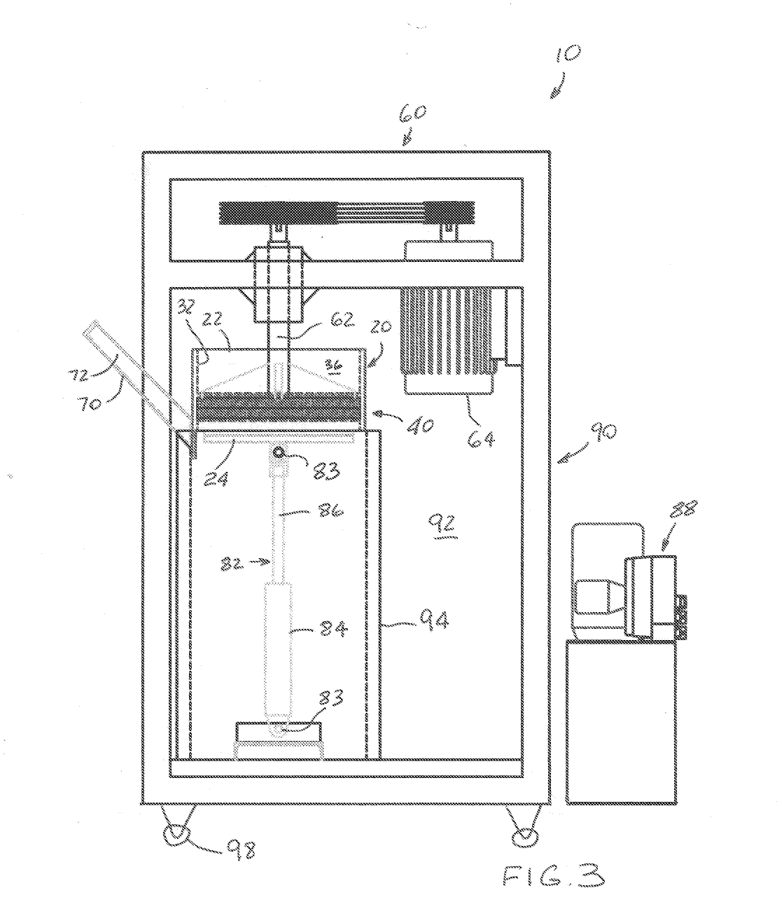

Another essential component of the apparatus 10 is a member, generally designated as 40, mounted for a rotation adjacent or in a proximity to the receptacle member 20 and having an abrasive working surface 50. Now in a particular reference to FIG. 3, the member 40 is illustrated as having a disk shaped member 42 and the abrasive working surface 50 being provided by a sheet of sand paper material 52 which is secured, preferably in a removable manner, to a surface 44 of the disk shaped member 42 by any conventional means, for example such as adhesives, clamps, mechanical fasteners and the like. Essentially, the disk shaped member 42 functions as a substrate or a backing member for such sheet of sand paper material 52.

Now in a particular reference to FIG. 2, the instant invention also contemplates that the abrasive working surface 50 may be secured in a permanent manner to the surface 44 of the disk shaped member 42 by way of abrasive particles 55 either being partially imbedded into or adhered onto the surface 44. Such abrasive particles 55 may be manufactured from tungsten carbide, industrial diamonds and the like materials. It would be understood that in any embodiment, the abrasive working surface 50 is sufficient to destroy, by grinding/sanding the one or more storage media devices 2, either completely or partially. The type of abrasive material may be selected to meet requirements of specific applications. By way of one example only, a high volume production application would benefit from the above described abrasive particles 55, reducing the frequency of the abrasive surface changeover.

The disk shaped member 42 is sized to fit, during use of the apparatus 10, into the hollow interior 36 of the receptacle member 20, wherein the abrasive working surface 50 is positioned, at assembly, toward the inner surface 26 of the closed bottom end 24 of the receptacle member 20.

There is also a power transmission means, generally designated as 60, for causing the rotation of the member 40. By way of one example only, such means 60 includes an elongated member 62 having a proximal end thereof rigidly attached to the disk shaped member 42 and extending in a vertical plane along the axis 12, a stationary bushing or guide 63 sized to receive the outer surface of the elongated member 62 therewithin, an electric motor 64 and a power transmission member 68 operatively connecting an output shaft 66 of the electric motor 64 and a distal end of the elongated member 62. The electric motor 64 and the power transmission member 68 are operable, in a combination with each other, to cause the rotation about a vertical axis 12, and wherein the abrasive working surface 50 of the member 40 rotates in a horizontal plane. In this embodiment, the power transmission member 68 includes a first pulley 68a mounted on the output shaft 64 of the electric motor 62, a second pulley 68b mounted on the distal end of the elongated member 62 and an endless belt 68c seated on the first and second pulleys, 68a and 68b respectively. The instant invention contemplates application of other configurations and components operable to cause the rotation of the disk shaped member 42. By way of examples only, the elongated member 62 and the output motor shaft 66 may be connected by way of gears (not shown) or the motor 64 may be directly coupled to the end of the elongated member 62 with a conventional coupling member (not shown).

Although one or more storage media devices 2 may be directly deposited into the hollow interior 36, the instant invention provides an optional chute 70 that is positioned to deliver, preferably due to gravity, the one or more storage media devices 2 into the hollow interior 36 of the receptacle member 20 and onto an inner surface 26 of the closed bottom end 24. The chute 70 advantageously affords users of the apparatus 10 to safely load the one or more storage media devices 2 into the hollow interior 36 of the receptacle 20 while the member 40 with the abrasive surface 50 is rotating.

The apparatus 10 also includes a means, generally designated as 80, for urging the one or more storage media devices 2 into a contact with the abrasive working surface 50 or providing/establishing a contact between the one or more storage media devices 2 and the abrasive working surface 50. Such means 80 preferably includes a hydraulic cylinder 82 having a fixed stationary portion 84 and further having a movable portion 86 thereof attached to an exterior surface of the receptacle member 20 and, more specifically to the outer surface 28 of the closed bottom end 24. The hydraulic cylinder 82 may be attached to the receptacle member 20 by one or more pivotal connections 83. The means 80 further includes a pump assembly 88 coupled to the hydraulic cylinder 82 and operable to generate a flow of a hydraulic fluid through the hydraulic cylinder 82, the flow causing the movable portion 84 to urge the one or more storage media devices 2, disposed within the hollow interior 36 and on the inner surface 26, toward the abrasive working surface 50 of the member 40 for the contact therewith.

The instant invention also contemplates that the hydraulic cylinder 82 may be replaced with a pneumatic cylinder, in combination with the pump assembly 88 being replaced by a pneumatic driving arrangement or, since the cylinder is a linearly actuated and/or movable device, even with an electrically driven member, for example such as a liner drive, coupled to a source of electric energy (not shown).

The apparatus 10 additionally includes a frame member 90 having a hollow interior 92 and wherein at least the receptacle member 20, the member 40 and the means 60 are mounted within the hollow interior 92 of the frame 90 and wherein the chute 70 is attached at an angle to the frame 90 and positioned to deliver the one or more storage media devices 2 into the hollow interior 36 of the receptacle member 20 and onto the irregular inner surface 24 of the closed bottom end 20. Although the pump assembly 88 is illustrated in FIGS. 2-3 as being positioned external to the frame 90, it may be mounted within the hollow interior 92 in a proximity to the receptacle 20.

In a further reference to FIGS. 1-2, the member 40 and, more particularly, the abrasive working surface 50, is positioned above the open end 22 of the receptacle member 20, wherein the means 80 for urging the one or more storage media devices 2 into the contact with the abrasive working surface 50 is operatively attached to the closed bottom end 24 of the receptacle member 20, whereby the receptacle member 20 is configured for a vertical movement toward the abrasive working surface 50 along the axis 12 and whereby the abrasive working surface 50 is shaped and sized to fit into the hollow interior 36 of the receptacle member 20.

The frame 90 advantageously includes a guide 94 mounted within the hollow interior 92 of the frame 90 in operative engagement with the receptacle member 20, the guide 94 configured to aid in the reciprocal vertical movement of the receptacle member 20. Furthermore, the frame 90, illustrated as an open type frame, may be fully or partially enclosed with optional skins (not shown).

The apparatus 10 may be controlled manually, by way of conventional switches (not shown) or by way of a control device (not shown), either of a conventional relay logic or a conventional microprocessor type and may further include a user interface of a graphic type. Such control device is well known in the art and it's description is omitted in this document for the sake of brevity.

In operation, the one or more storage media devices 2 are inserted into the opening 72 of the chute 70 either manually or by an optional motorized member, for example such as the conveyor 4, partially illustrated in FIG. 2. Because, the chute 70 is inclined, the one or more storage media devices 2 are delivered, preferably by gravity, onto the inner surface 26 of the closed bottom end 24 of the receptacle 20. Advantageously, the hollow interior 36 is sized to receive therewithin a plurality of storage media devices 2. When the hollow interior 36 is sufficiently filled with storage media devices 2, the pump assembly 88 is operated to deliver fluid flow to the bottom end of the hydraulic cylinder 82, causing movable portion 86 thereof to extend upwardly and move the receptacle member 20 toward the abrasive working surface 50, as is best shown in FIG. 3, wherein the disk shaped member 42 is at least partially disposed within the hollow interior 36. The means 60 are also operated to enact the rotation of both the member 40 and the abrasive working surface 50. Such rotating abrasive working surface 50 begins transforming (by grinding or sanding) the one or more storage media devices 2 upon the contact therewith by continuously removing thickness layers thereof. Continuing upward movement of the receptacle member 20 urges, under pressure, all storage media devices 2 into the contact with the abrasive working surface 50 and assures that the entire quantity of the storage media devices 2 received within the hollow interior 36 is destructed or transformed sufficiently to prevent data mining from remnant(s) thereof or from the ground particles. In other words, it is not necessary to completely destroy each storage media device 2, as long as at least a portion thereof is transformed into particles so that the digital information cannot be recovered or retrieved from the remnant(s) of the storage media device 2. The ground particles of the storage media devices 2 are discharged, due to rotation and pressure, through the apertures 38 formed through the peripheral side wall 30. When all storage media devices 2 are sufficiently destructed or transformed, the fluid flow is reversed, enacting downward movement of the movable portion 88 and the receptacle member 20 into the original position of FIG. 2. Any remnant(s) of the storage media devices 2, that have not been destructed or transformed into particles, are removed, for example manually, from the hollow interior 36 and the apparatus 10 is prepared to destruct the next batch of the storage media devices 2.

The invention also contemplates an optional means for collecting ground particles. By way of one example only, the frame 90 can be provided of a closed type with an opening to receive an end of any suitable collection device (not shown) by way of suction.

The invention further contemplates that the receptacle 20 may be mounted for a rotation and the member 40 with the abrasive working surface 50 is mounted for such linear reciprocal movement by connecting the receptacle 20 to the means 60 and by connecting the member 40 to the means 80.

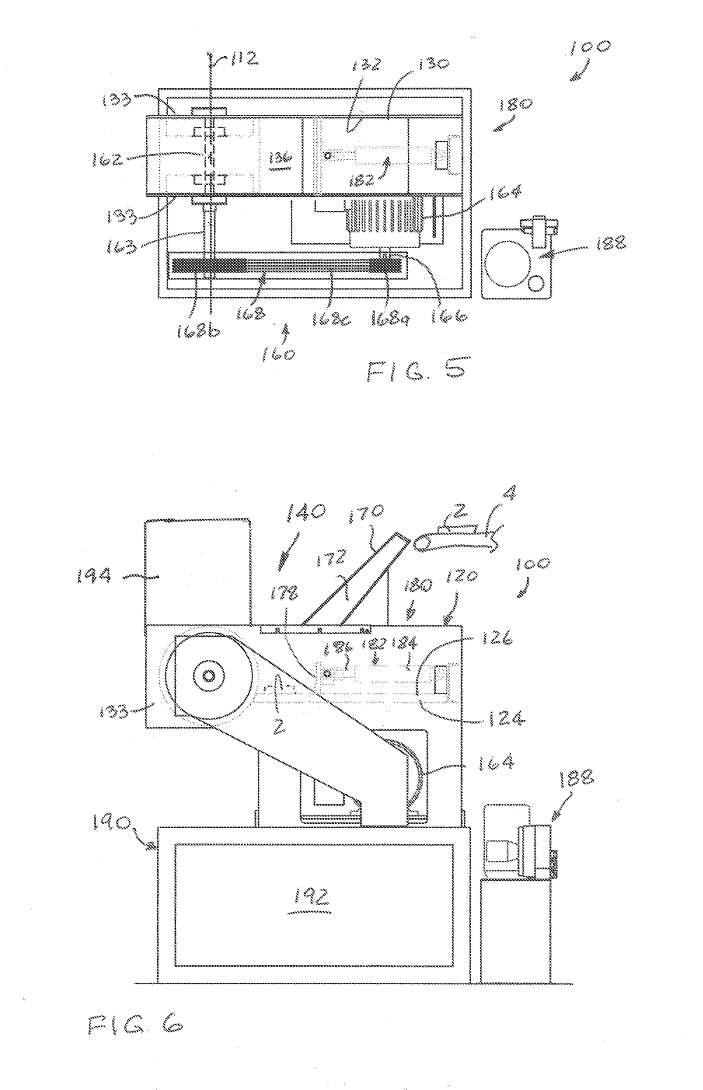

Reference is now made, to FIGS. 5-8, wherein there is shown an apparatus, generally designated as 100, for destroying storage media devices 2 used for storage and retrieval of digital information. The apparatus 100 comprises a receptacle member, generally designated as 120, having at least partially and even completely open top end 122, a closed bottom end 124 and a pair of side wall 130 defining a hollow interior 136 of the receptacle member 120. The hollow interior 136 of the receptacle member 120 is sized to receive therein at least one and preferably a plurality of storage media devices 2. An inner surface 126 of the closed bottom member 120 may be adapted with the above described irregular shape so as to at least minimize a movement of the one or more storage media devices 2 delivered thereonto.

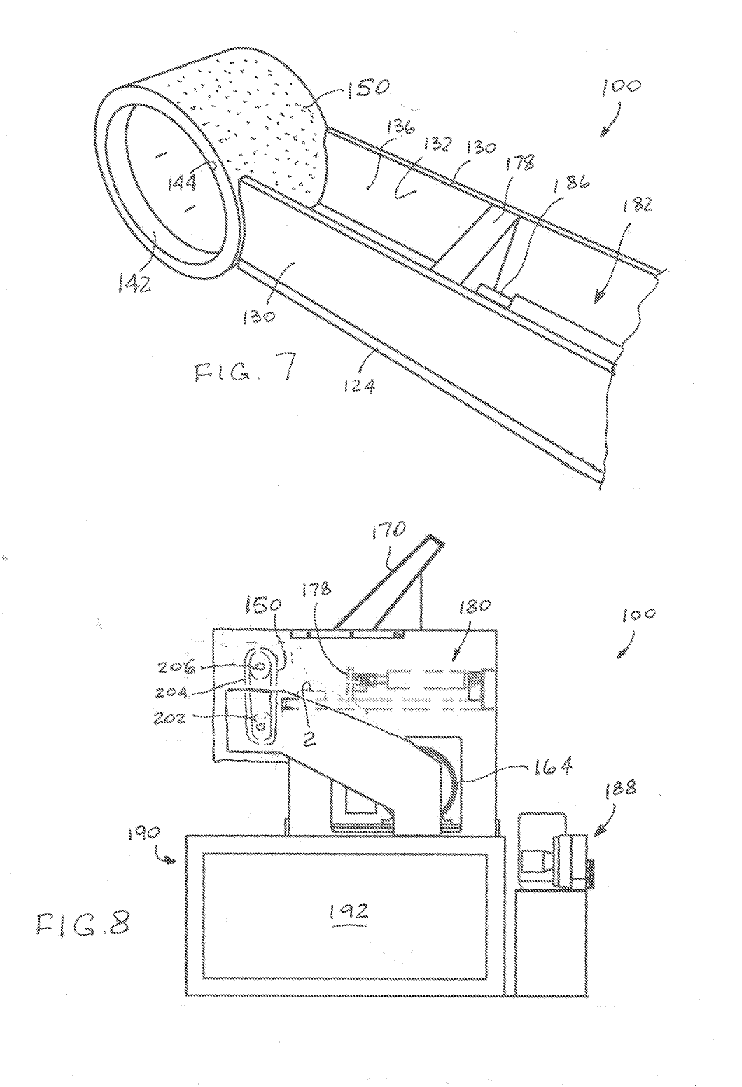

Another essential component of the apparatus 100 is a member, generally designated as 140, mounted for a rotation adjacent or in a proximity to the receptacle member 120 and having an abrasive working surface 150. Now in a particular reference to FIG. 6, the member 140 is illustrated as having a wheel shaped member 142 and the abrasive working surface 150 is provided by an endless belt of a sand paper material 152 which is secured, preferably in a removable manner, to a surface 144 of the wheel shaped member 142 by any conventional means, for example such as adhesives, clamps, mechanical fasteners and the like. The instant invention also contemplates that the abrasive working surface 150 may be secured in a permanent manner to the surface 144 of the wheel shaped member 142 by way of the above described abrasive particles 55 either being partially imbedded into or adhered onto the surface 144.

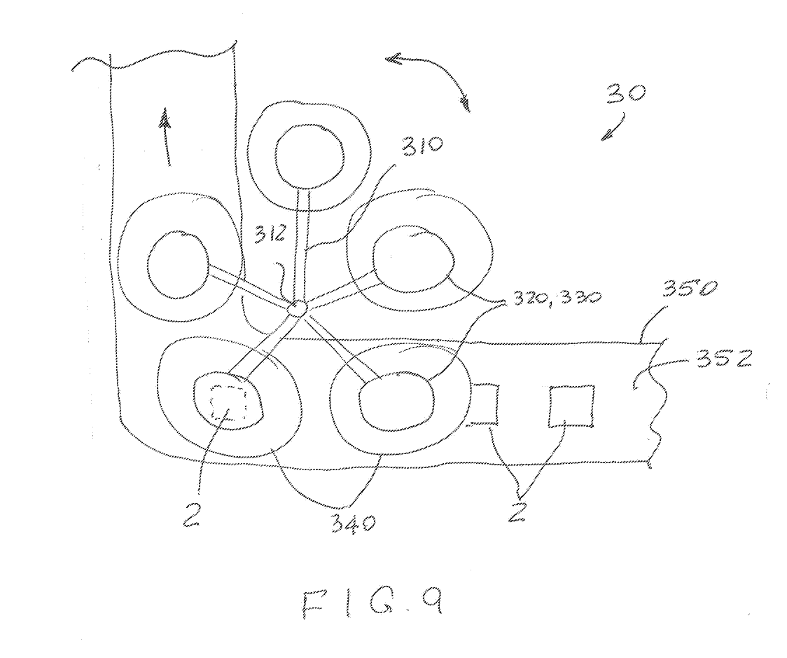

The wheel shaped member 142 is positioned at one end of the receptacle member 120, wherein the respective ends of the side walls 130 are curved inwardly to compliment the curvature of the wheel shaped member 142 and also provide a gap preventing friction between the wheel shaped member 142 and respective ends of the side walls 130 but being sufficient narrow to prevent escape of larger than desired remnants of the in-process storage media devices 2. Although the width of the wheel shaped member 142 is shown in FIG. 7 as being larger than the width of the receptacle member 120, such wheel shaped member 142 may be sized to be positioned between inner surfaces 132 of the side walls 130.

Advantageously, the side walls 130 are adapted with portions 133 that are used to mount an elongated member 162 that functions as a rotational axle for the wheel shaped member 142 and that has a portion 163 thereof extending in a horizontal plane from one end of the wheel shaped member 142.

There is also a means, generally designated as 160, for causing the rotation of the member 140. By way of one example only, such means 60 includes, an electric motor 164 and a power transmission member 168 operatively connecting an output shaft 166 of the electric motor 164 and a distal end of the portion 163 of the elongated member 162, the electric motor 164 and the power transmission member 168 operable to cause the rotation about a horizontal axis 112, and wherein the abrasive working surface 150 of the member 140 rotates in a vertical plane. The power transmission member 168 includes a first pulley 168a mounted on the output shaft 164 of the electric motor 162, a second pulley 168b mounted on the distal end of the elongated member 162 and an endless belt 168c seated on the first and second pulleys, 168a and 168b respectively. Preferably, except for the length and diameter of the elongated member 162, remaining components of the means 140 is essentially identical to the above described means 40.

FIG. 8 illustrates an alternative form of the apparatus of FIG. 5, wherein the wheel shaped member 142 has been replaced with a driving pulley 202, being connected to the motor 164, and a driven pulley 206 and wherein the working surface 150 is provided by a conventional belt 204.

The instant invention also contemplates that the above described rotating member 40 may be adapted for a rotation about a horizontally disposed axis to destruct one or more storage media devices 2.

The top end 122 can be partially or fully open for depositing one or more storage media devices 2, however the instant invention contemplates a generally closed top end 122 and a use of an optional chute 170 being attached to upper edges of the side walls 130 or to the top end 122 and being positioned to deliver the one or more storage media devices 2 into the hollow interior 136 of the receptacle member 120 and onto an inner surface 126 of the closed bottom end 124.

The apparatus 100 also includes a means, generally designated as 180, for urging the one or more storage media devices 2 for a contact with the abrasive working surface 150 or providing/establishing a contact between the one or more storage media devices 2 and the abrasive working surface 150. Such means 180 includes a movable ram member, for example being a plate shaped member 178, or equivalent, which is mounted for a linear reciprocal movement in a horizontal plane within the hollow interior 136 such so that each end of the plate shaped member 178 is positioned in a close proximity to an inner surface 132 of a respective side wall 130. Means 180 further includes a hydraulic cylinder 182 having a fixed stationary portion 184 and having a movable portion 186 thereof attached one surface of the plate shaped member 178. The means 180 further includes a pump assembly 188 coupled to the hydraulic cylinder 182 and operable to generate a flow of a hydraulic fluid through the hydraulic cylinder 182, the flow causing the hydraulic cylinder 82 to urge the one or more storage media devices 2 into the contact with the abrasive working surface 150 of the member 140. The invention contemplates that the hydraulic cylinder 182 and the pump assembly 188 are essentially identical to the above described the hydraulic cylinder 82 and the pump assembly 88.

As has been described above, the hydraulically operated means 180 may be provided of a pneumatic or electric type.

The apparatus 100 additionally includes a frame member 190, wherein at least the receptacle member 120, the member 140 and the means 160 are supported on the frame 190, as best shown in FIG. 6. The frame 190 may be provided as a closed housing with a hollow interior 192 wherein the apparatus 100 is configured to deliver the ground particles into such hollow interior 192 for further disposal. Or the apparatus 100 may include an optional suction type collector 194, diagrammatically illustrated in FIG. 6, mounted in a position to collect the ground particles from the one or more storage media devices 2.

The apparatus 100 may be controlled manually, by way of conventional switches (not shown) or by way of a control device (not shown), either of a conventional relay logic or a conventional microprocessor type and may further include a user interface of a graphic type. Such control device is well known in the art and it's description is omitted in this document for the sake of brevity.

In operation, the one or more storage media devices 2 are inserted into the opening 172 of the chute 170 either manually or by an optional motorized member, for example such as the conveyor 4, partially illustrated in FIG. 6. Because, the chute 170 is inclined, the one or more storage media devices 2 are delivered, by gravity, onto the inner surface 126 of the closed bottom end 124. Advantageously, the hollow interior 136 is sized to receive therewithin a plurality of storage media devices 2. When the hollow interior 136 is sufficiently filled with storage media devices 2, the pump assembly 188 is operated to deliver fluid flow to the right end of the hydraulic cylinder 182, causing movable portion 186 thereof to extend to the left in FIG. 6 and move the plate shaped member 178 toward the contact with the abrasive working surface 150. The means 160 is also operated to enact rotation of the member 140 and the abrasive working surface 150. Such rotating abrasive working surface 150 begins grinding the storage media devices 2 upon the contact therewith. Continuing movement of the plate shaped member 178 urges, under pressure, all storage media devices 2 into the contact with the abrasive working surface 150 and assures that the entire quantity of the storage media devices 2 received within the hollow interior 136 is destructed sufficiently to prevent data mining from remnant(s) thereof or from the particles. In other words, it is not necessary to completely destroy each storage media device 2, as long as at least a portion thereof is transformed into particles so that the digital information cannot be recovered or retrieved from the remnant(s) of the storage media device 2. The ground particles of the storage media devices 2 are discharged, due to rotation and pressure, through gaps formed between the ends of the side wall 130 and the bottom end 120. When all storage media devices 2 are sufficiently destructed, the fluid flow is reversed, enacting movement of the movable portion 188 to the right of FIG. 6, thus returning the plate shaped member into the original position to accept or receive next batch of storage media devices 2. Any remnant(s) of the storage media devices 2, that have not been destructed into particles, are removed, for example manually, from the hollow interior 136 and the apparatus 100 is prepared to destruct the next batch of the storage media devices 2.

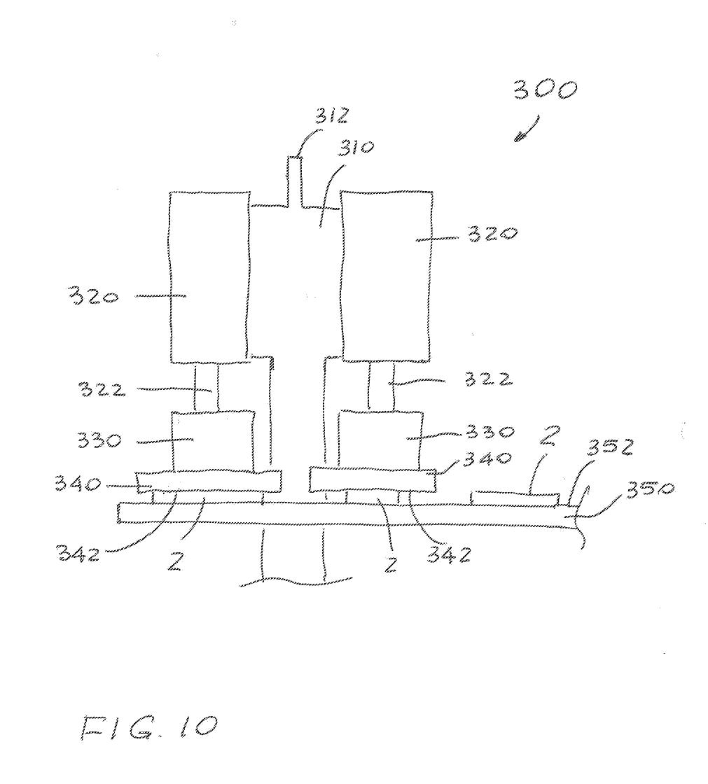

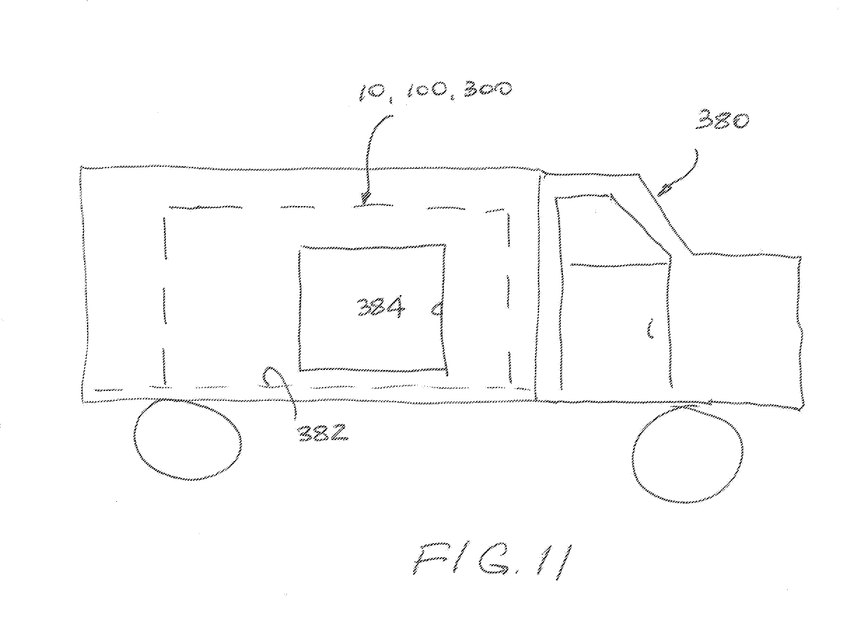

Now in reference to FIGS. 9-10, therein is illustrated an apparatus, generally designated as 300, that is constructed in accordance with another embodiment of the invention. The apparatus 300 includes a member or frame 310 mounted for a rotation in a horizontal plane about a vertical axis. By way of one example only, the member 310 may be coupled, at the end 312, to the means 60 or 160 of FIGS. 1-3 and 5-6, which are omitted in FIGS. 9-10, for the sake of clarity. Cylinder or cylinders 320, for example of a hydraulic type, or equivalent, are mounted/supported on the member 310 for a rotation therewith and are coupled to the means 80 described above. A rotating head 330 is mounted at a distal end 324 of a movable portion 322 of each cylinder 320. The rotating head 330 includes a motor 332, which could be of a servo motor type, or an equivalent device, and a member 340, preferably having a disk shape, attached to the motor 332 and defining an abrasive working surface 342, of any type described above, facing downwardly in the vertical direction and rotating in a horizontal plane about a longitudinal axis of each cylinder 320. There is also a conveyor 350 that includes a curved portion 352 that compliments the rotation of the member 310 and essentially positions a top surface 354 thereof under the abrasive working surfaces 342. Essentially, the conveyor 350 provides an open receptacle and may be even adapted with vertically disposed side walls (not shown).

The apparatus 300 may be controlled manually, by way of conventional switches (not shown) or by way of a control device (not shown), either of a conventional relay logic or a conventional microprocessor type and may further include a user interface of a graphic type. Such control device is well known in the art and it's description is omitted in this document for the sake of brevity.

In operation, the storage media devices 2 are placed, onto the top surface 354. The storage media devices 2 can be placed in any pattern, but preferably, are placed in a spaced apart relationship with each other. As the storage media device 2 moves for positioning under a next available rotating abrasive working surface 342, the movable portion 322 of the hydraulic cylinder 320 is commanded to move downwardly so as to provide/establish a contact between the with the storage media device 2 and the abrasive working surfaces 342. Such downward movement continues progressively as the storage media device 2 is carried by the conveyor 350 and the abrasive working surface 342 rotate causing destruction of the storage media device 2.

The number of members 340 and the size of the abrasive working surface 342 are selected based on a particular application and the size/type of the storage media devices 2.

Thus, in one embodiment, an apparatus for destroying storage media devices used for storage and retrieval of digital information comprises a receptacle member having an open top end, a closed bottom end and a peripheral side wall or a pair of side walls defining a hollow interior of the receptacle member, the hollow interior of the receptacle member sized to receive therein one or more storage media devices; a member mounted for a rotation adjacent the receptacle member and having an abrasive working surface; a means for causing the rotation of the abrasive member; a chute positioned to deliver the one or more storage media devices into the hollow interior of the receptacle member and onto an inner surface of the closed bottom end; a means for urging the one or more storage media devices for a contact with the abrasive working surface; wherein the rotation of the member transforms at least a portion of the one or more storage media devices contacting the abrasive member into particles; and whereby the one or more storage media devices are destructed sufficiently to prevent data mining from remnant(s) thereof or from the particles.

In another embodiment, an apparatus for destroying storage media devices used for storage and retrieval of digital information comprises a frame, having a hollow interior; a receptacle member positioned within the hollow interior and having an open top end, a closed bottom end and a peripheral side wall defining a hollow interior of the receptacle member, the closed bottom end having an irregular inner surface, the hollow interior of the receptacle member sized to receive therein one or more storage media devices; apertures formed through the peripheral side wall in proximity to the closed bottom end; a hydraulic cylinder disposed in a vertical plane, the hydraulic cylinder having a stationary portion thereof attached to one portion of the frame and having a movable portion thereof attached to an outer surface of the closed end of the receptacle member; a pump assembly coupled to the hydraulic cylinder and operable to generate a flow of a hydraulic fluid through the hydraulic cylinder, the flow causing a reciprocal vertical movement of the receptacle member; a guide mounted within the hollow interior of the frame in operative engagement with the receptacle member, the guide configured to aid in the reciprocal vertical movement of the receptacle member; a member sized and shaped to fit into the hollow interior of the receptacle member; an abrasive material disposed on a first surface of the member and defining an abrasive working surface thereof, the abrasive working surface positioned, at assembly, toward the irregular inner surface of the closed bottom end of the receptacle member; an elongated member having a proximal end thereof rigidly attached to an axially opposite second surface of the member, the elongated member extending in a vertical plane; an electric motor attached to one portion of the frame; a power transmission member operatively connecting an output shaft of the electric motor and a distal end of the elongated member, the electric motor and the power transmission member operable to cause a rotation of the elongated member, the member and the abrasive material about a vertical axis, wherein the first surface of the member rotates in a horizontal plane; a chute attached at an angle to the frame and positioned to deliver the one or more storage media devices into the hollow interior of the receptacle member and onto the irregular inner surface of the closed bottom end; wherein the vertical movement of the receptacle member in an upward direction urges the one or more storage media devices into a contact with the abrasive material; wherein the irregular inner surface at least minimizes lateral movement of the one or more storage media devices delivered thereonto; wherein the rotation of the abrasive material transforms at least a portion of the one or more storage media devices contacting the abrasive material into particles that exit the hollow interior of the receptacle member through the apertures formed through a side wall thereof; and whereby the one or more storage media devices are destructed sufficiently to prevent data retrieval from remnant(s) thereof or from the particles.

In a further embodiment, an apparatus for destroying storage media devices used for storage and retrieval of digital information comprises a frame, having a hollow interior; a receptacle member having an open top end, a closed bottom end and a pair of side wall upstanding on an inner surface of the closed bottom end and defining a hollow interior of the receptacle member, the hollow interior of the receptacle member sized to receive therein one or more storage media devices; a plate shaped member sized and shaped to fit into the hollow interior of the receptacle member and having each end thereof positioned in a close proximity to an inner surface of a respective side wall; a hydraulic cylinder disposed in a horizontal plane, the hydraulic cylinder having a stationary portion thereof attached to one portion of the frame and having a movable portion thereof attached to a surface of the member; a pump assembly coupled to the hydraulic cylinder and operable to generate a flow of a hydraulic fluid through the hydraulic cylinder, the flow causing a reciprocal horizontal movement of the member within the hollow interior of the receptacle member; an elongated member mounted for a rotation about a horizontal axis; a wheel mounted on the elongated member for the rotation therewith, the wheel having a width thereof being sized to fit into the hollow interior of the receptacle member; an abrasive material disposed on a peripheral surface of the wheel for the rotation therewith and defining an abrasive working surface thereof; an electric motor attached to one portion of the frame; a power transmission member operatively connecting an output shaft of the electric motor and a distal end of the axle, the electric motor and the power transmission member operable to cause a rotation of the elongated member, the wheel and the abrasive material about the horizontal axis; a chute attached at an angle to the receptacle member and positioned to deliver the one or more storage media devices into the hollow interior of the receptacle member and onto an inner surface of the closed bottom end; wherein the horizontal movement of the plate shaped member in a direction toward the wheel urges the one or more storage media devices into a contact with the abrasive material; wherein the rotation of the abrasive material transforms at least a portion of the one or more storage media devices contacting the abrasive material into particles; and whereby the one or more storage media devices are destructed sufficiently to prevent data retrieval from remnant(s) thereof or from the particles.

The apparatus 10, 100 may be provided with wheels 98 for portability purposes and ease of movement.

In yet a further embodiment, an apparatus for destroying storage media devices used for storage and retrieval of digital information comprises a frame mounted for a rotation around a vertically disposed axis; cylinders mounted on the frame for the rotation therewith, wherein a movable portion of each cylinder moves in a vertical direction; a member mounted at an end of the movable portion of the each cylinder for a rotation in a horizontal plane about a longitudinal axis of each cylinder and for the rotation about the vertically disposed axis, the member defining an abrasive working surface; and a conveyor having a top surface thereof positioned to face the abrasive working surface and having a curved portion shaped to complement the rotation of the frame, wherein the abrasive working surface is moved downwardly during the rotation thereof and during a movement of the conveyor sufficient to transform at least a portion of the one or more storage media devices, contacting the abrasive material, into particles sufficient to prevent data retrieval therefrom.

In another embodiment the invention provide a method of destroying, in a volume or batch manner, storage media devices used for storage and retrieval of digital information. The method comprises the step of providing a receptacle having a surface to receive one or more storage media devices thereon. Next, mounting, one or more members for a rotation in a proximity to the receptacle member and adapting each member with an abrasive working surface. Then, rotating the abrasive working surface. Depositing the one or more storage media devices onto the surface. Next, contacting the one or more storage media devices with the abrasive working surface. Then, sufficiently transforming into particles, with the rotation, at least a portion of the one or more storage media devices contacting the abrasive member so as to prevent data mining from remnants thereof or from the particles.

In a further embodiment, an apparatus for destroying, in a volume or a batch manner, storage media devices used for storage and retrieval of digital information comprises a receptacle receiving storage media devices on a surface thereof; one or more members mounted for a rotation in a proximity to the receptacle member and having an abrasive working surface; a power transmission means for rotating the abrasive working surface; a linearly movable device or devices operable to provide a contact between each storage media devices and the abrasive working surface; wherein the rotation of the one or more members transforms at least a portion of the each storage media device contacting the abrasive member into particles; and whereby the storage media devices are transformed sufficiently to prevent data mining from remnants thereof or from the particles.

Now in a reference to FIG. 11, the apparatus 10, 100 or 300 or components thereof may be mounted on a truck bed 382 of a vehicle 380 equipped with an access door or panel 382 or with a conventional rear door or doors (not shown). Thus, the invention also contemplates that apparatus 10, 100 or 300 is provided as a truck mounted mobile storage media destruction system. The apparatus 10, 100 or 300 can be adapted onto any trucks used currently for material shredding efforts.

By way of one example, the apparatus 10, 100 or 300 may replace a first feed system 18, a hammer mill 20 (200) and a second feed system 22 described in U.S. Pat. No. 6,719,226 issued to Rajewski on Apr. 13, 2004. Or the invention may adapt the first feed system 18 to deliver one or more storage media devices 2. Teachings of U.S. Pat. No. 6,719,226 are incorporated herein by reference thereto.

By way of another example, the apparatus 10, 100 or 300 or components thereof may be integrated into a mobile shredder disclosed in U.S. Pat. No. 7,198,213 issued to Kolbert, et al. on Apr. 3, 2007. Teachings of U.S. Pat. No. 7,198,213 are incorporated herein by reference thereto.

Thus, the specific truck design does not constitute a limitation of the instant invention.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

What is claimed is:

1. An apparatus for destroying storage media devices used for storage and retrieval of digital information, said apparatus comprising:
(a) a receptacle member having an open top end, a closed bottom end and a peripheral side wall or a pair of side walls defining a hollow interior of said receptacle member, said hollow interior of said receptacle member sized to receive therein one or more storage media devices;
(b) a member mounted for a rotation adjacent to said receptacle member and having an abrasive working surface;
(c) a means for causing said rotation of said member having said abrasive working surface;
(d) a means for urging the one or more storage media devices into a contact with said abrasive working surface;
(e) wherein said rotation of said member transforms at least a portion of the one or more storage media devices contacting said abrasive member into particles; and
(f) whereby the one or more storage media devices are transformed sufficiently to prevent data mining from remnant or remnants thereof or from said particles.

2. The apparatus of claim 1, wherein said abrasive member has one of a disk and a wheel shape.

3. The apparatus of claim 2, wherein said abrasive member has said disk shape and is sized to fit into said hollow interior of said receptacle member during use of said apparatus and wherein said abrasive working surface is positioned, during the use of said apparatus, to face an inner surface of said closed bottom end of said receptacle member.

4. The apparatus of claim 3, wherein said abrasive working surface includes a material being secured to a substrate in one of a permanent and a removable manner.

5. The apparatus of claim 1, comprising an elongated member extending in a vertical plane and having a proximal end thereof rigidly attached to said member, wherein said means for causing said rotation of said abrasive member includes an electric motor and a power transmission member operatively connecting an output shaft of said electric motor and a distal end of said elongated member, said electric motor and said power transmission member operable to cause said rotation about a vertical axis, and wherein said abrasive working surface of said member rotates in a horizontal plane during use of said apparatus.

6. The apparatus of claim 5, wherein said power transmission member includes a first pulley mounted on said output shaft of said electric motor, a second pulley mounted on said distal end of said elongated member and an endless belt seated on said first and second pulleys.

7. The apparatus of claim 1, wherein said means for urging the one or more storage media devices into said contact with said abrasive working surface includes a hydraulic cylinder having a fixed stationary portion and having a movable portion thereof attached to an exterior surface of said receptacle member or to a movable member positioned within said hollow interior of said receptacle member during use of said apparatus and a pump assembly coupled to said hydraulic cylinder and operable to generate a flow of a hydraulic fluid through said hydraulic cylinder, said flow causing said hydraulic cylinder to urge the one or more storage media devices into said contact with said abrasive working surface.

8. The apparatus of claim 7, wherein said movable member is positioned within said hollow interior of said receptacle member.

9. The apparatus of claim 8, wherein said receptacle member includes a bottom member and a pair of spaced apart side walls upstanding on said bottom member and wherein said movable member is mounted for a linear reciprocal movement in a horizontal plane during use of said apparatus and has each end thereof positioned in a close proximity to an inner surface of a respective side wall.

10. The apparatus of claim 1, wherein said abrasive member is positioned above said open end of said receptacle member being in a position to receive the one or more storage media devices therewithin, wherein said means for urging the one or more storage media devices into said contact with said abrasive member is operatively attached to said closed bottom end of said receptacle member, whereby said receptacle member is configured for a vertical movement toward said member having said abrasive working surface and whereby said member having said abrasive working surface is shaped and sized to fit into said hollow interior of said receptacle member.

11. The apparatus of claim 1, further comprising a frame and wherein at least said receptacle member, said member having said abrasive working surface and said means for causing said rotation of said member are mounted within a hollow interior of said frame or on a surface thereof.

12. The apparatus of claim 1, further comprising a chute positioned to deliver, by gravity, the one or more storage media devices into said hollow interior of said receptacle member and onto an inner surface of said closed bottom end.

13. The apparatus of claim 1, further comprising a conveyor positioned to deposit the one or more storage media devices into an opening of said chute.

14. The apparatus of claim 1, wherein said member having said abrasive working surface is a belt and wherein said means for causing said rotation of said member having said abrasive working surface includes a pair of pulleys, one of said pair of pulleys is coupled to said member having said abrasive working surface.

15. The apparatus of claim 1, further comprising a collector mounted in a position to collect ground particles from the one or more storage media devices.

16. An apparatus for destroying storage media devices used for storage and retrieval of digital information, said apparatus comprising:
(a) a frame, having a hollow interior;
(b) a receptacle member positioned within said hollow interior and having an open top end, a closed bottom end and a peripheral side wall defining a hollow interior of said receptacle member, said closed bottom end having an irregular inner surface, said hollow interior of said receptacle member sized to receive therein one or more storage media devices;
(c) apertures formed through said peripheral side wall at least in a proximity to said closed bottom end;
(d) a hydraulic cylinder disposed in a vertical plane, said hydraulic cylinder having a stationary portion thereof attached to one portion of said frame and having a movable portion thereof attached to an outer surface of said closed end of said receptacle member;
(e) a pump assembly coupled to said hydraulic cylinder and operable to generate a flow of a hydraulic fluid through said hydraulic cylinder, said flow causing a reciprocal vertical movement of said receptacle member;
(f) a guide mounted within said hollow interior of said frame in an operative engagement with said receptacle member, said guide guides said reciprocal vertical movement of said receptacle member;
(g) a member sized and shaped to fit into said hollow interior of said receptacle member;
(h) an abrasive material disposed on a first surface of said member and defining an abrasive working surface thereof, said abrasive working surface positioned, during use of said apparatus, to face said irregular inner surface of said closed bottom end of said receptacle member;
(i) an elongated member having a proximal end thereof rigidly attached to an axially opposite second surface of said member, said elongated member extending in said vertical plane during the use of said apparatus;
(j) an electric motor attached to one portion of said frame;
(k) a power transmission member operatively connecting an output shaft of said electric motor and a distal end of said elongated member, said electric motor and said power transmission member operable to cause a rotation of said elongated member, said member and said abrasive material about a vertical axis, wherein said first surface of said member rotates in a horizontal plane during the use of said apparatus;
(l) a chute attached at an inclined angle to said frame and positioned to deliver, due to gravity, the one or more storage media devices into said hollow interior of said receptacle member and onto said irregular inner surface of said closed bottom end;
(m) wherein said vertical movement of said receptacle member in an upward direction urges the one or more storage media devices into a contact with said abrasive material;
(n) wherein said irregular inner surface at least minimizes lateral movement of the one or more storage media devices delivered thereonto;
(o) wherein said rotation of said abrasive material transforms at least a portion of the one or more storage media devices contacting said abrasive material into particles that exit said hollow interior of said receptacle member through said apertures formed through said peripheral side wall thereof; and
(p) whereby the one or more storage media devices are transformed sufficiently to prevent data retrieval from remnant or remnants thereof or from said particles.

17. An apparatus for destroying storage media devices used for storage and retrieval of digital information, said apparatus comprising:
(a) a frame, having a hollow interior;
(b) a receptacle member having an open top end, a closed bottom end and a pair of side wall upstanding on an inner surface of said closed bottom end and defining a hollow interior of said receptacle member, said hollow interior of said receptacle member sized to receive therein one or more storage media devices;
(c) a member sized and shaped to fit into said hollow interior of said receptacle member and having each end thereof positioned in a close proximity to an inner surface of a respective side wall;
(d) a hydraulic cylinder disposed in a horizontal plane, said hydraulic cylinder having a stationary portion thereof attached to one portion of said frame and having a movable portion thereof attached to a surface of said member;
(e) a pump assembly coupled to said hydraulic cylinder and operable to generate a flow of a hydraulic fluid through said hydraulic cylinder, said flow causing a reciprocal horizontal movement of said member within said hollow interior of said receptacle member;
(f) an elongated member mounted for a rotation about a horizontal axis;
(g) a wheel mounted on said elongated member for said rotation therewith, said wheel having a width thereof being sized to fit into said hollow interior of said receptacle member;
(h) an abrasive material disposed on a peripheral surface of said wheel for said rotation therewith and defining an abrasive working surface thereof;
(i) an electric motor attached to one portion of said frame;
(j) a power transmission member operatively connecting an output shaft of said electric motor and a distal end of said axle, said electric motor and said power transmission member operable to cause a rotation of said elongated member, said wheel and said abrasive material about said horizontal axis;
(k) a chute attached at an angle to said receptacle member and positioned to deliver, due to gravity, the one or more storage media devices into said hollow interior of said receptacle member and onto an inner surface of said closed bottom end;
(l) wherein said horizontal movement of said member in a direction toward said wheel urges the one or more storage media devices into a contact with said abrasive material;
(m) wherein said rotation of said abrasive material transforms at least a portion of the one or more storage media devices contacting said abrasive material into particles; and
(n) whereby the one or more storage media devices are transformed sufficiently to prevent data retrieval from remnant(s) thereof or from said particles.

18. An apparatus for destroying storage media devices used for storage and retrieval of digital information, said apparatus comprising:
(a) a frame mounted for a rotation around a vertically disposed axis;
(b) cylinders mounted on said frame for said rotation therewith, wherein a movable portion of each cylinder moves in a vertical direction;
(c) a member mounted at an end of said movable portion of said each cylinder for a rotation in a horizontal plane about a longitudinal axis of each cylinder and for said rotation about said vertically disposed axis, said member defining an abrasive working surface; and
(d) a conveyor having a top surface thereof positioned to face said abrasive working surface and having a curved portion shaped to complement said rotation of said frame, wherein said abrasive working surface is moved downwardly during said rotation thereof and during a movement of said conveyor sufficient to transform at least a portion of the one or more storage media devices, contacting said abrasive material, into particles sufficient to prevent data retrieval therefrom.

19. An apparatus for destroying, in a volume or a batch manner, storage media devices used for storage and retrieval of digital information, said apparatus comprising:
(a) a receptacle receiving storage media devices on a surface thereof;
(b) one or more members mounted for a rotation in a proximity to said receptacle member and having an abrasive working surface;
(c) a power transmission means for rotating said abrasive working surface;
(d) a linearly movable device or devices operable to provide a contact between each storage media devices and said abrasive working surface;
(e) wherein said rotation of said one or more members transforms at least a portion of the each storage media device contacting said abrasive member into particles; and
(f) whereby the storage media devices are transformed sufficiently to prevent data mining from remnants thereof or from said particles.

20. The apparatus of claim 19, further comprising a vehicle and wherein said apparatus is mounted on a bed of said vehicle.
